(19) United States
(12) Patent Application Publication
(10) Pub. No.: US 2006/0020372 A1
(43) Pub. Date: Jan. 26, 2006

(54) System for communicating between a master device and each of slave devices

(75) Inventor: Nobuya Watabe, Nagoya (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/137,546

(22) Filed: May 26, 2005

(30) Foreign Application Priority Data
May 28, 2004 (JP) 2004-159598

(51) Int. Cl. G06F 15/16; G06F 7/00

(52) U.S. Cl. 701/1; 709/208

(57) ABSTRACT

An ECU outputs request signals with different identifiers to a communication line one after another in a manner that one of there quest signals is firstly outputted, and each of the other request signals is outputted when the ECU detects a response signal transmitted through the communication line. Each of receivers independently sets a monitoring period of time, receives the request signals from the communication line and performs an identifier setting judgment every request signal. In this judgment, the receiver monitors the communication line during the monitoring period of time starting upon reception of the request signal unless the receiver has outputted a response signal, outputs a response signal to the communication line when the receiver detects no response signal transmitted through the communication line in the monitoring, and sets an identifier included in the request signal when the receiver outputs the response signal.

### CROSS-REFERENCE TO RELATED APPLICATION

This application is based upon and claims the benefit of priority of the prior Japanese Patent Application 2004-159598 filed on May 28, 2004 so that the contents of which are incorporated herein by reference.

### BACKGROUND OF THE INVENTION

1. Field of the Invention

The present invention generally relates to a communication system wherein a master device communicates with a plurality of slave devices through a common communication line while identifying each of the slave devices based on an identifier uniquely assigned to the slave device.

2. Description of Related Art

A communication system such as a local interconnect network (LIN) used, for example, for communication among units of an in-vehicle control system has been known. In this system, a master device is connected with a plurality of slave devices through a common communication line (or single communication line in case of LIN), and each slave device transmits data to the master device through the communication line in response to a request of the master device.

More particularly, identifier data (ID) is uniquely assigned to each of slave devices in advance to identify each slave device. When a master device desires to communicate with a remarked slave device, the master device transmits a request signal including an ID of the remarked slave device to all slave devices. Each slave device compares the transmitted ID with an ID thereof, and the IDs are identical with each other in the remarked slave device. Then, only the remarked slave device communicates with the master device in response to the request signal. Therefore, it is required that the master device provides each of slave devices with an ID peculiar to the slave device.

Generally, a device used as a slave device has a DIP switch to assign an ID thereto. When a user connects the device to a communication line to use the device as a slave device, the user also manipulates the DIP switch to manually assign an ID to the slave device.

Further, International Application Publication No. W001/070520 of PCT/EP01/01175 (or Japanese Translation of PCT No. 2003-528378) proposes a communication system wherein an ID is automatically assigned to each slave device without user's manipulation of a DIP switch. More particularly, a connector connected with a communication line is disposed near a slave device, and a unique ID is assigned to the connector in advance. When a device used as a slave device is connected to the connector, the ID assigned to the connector is automatically registered to the slave device as an ID of the slave device.

This communication system has a plurality of receivers, respectively, disposed near tires of a vehicle and a monitor disposed in a vehicle body. Each receiver receives information of tire inflation pressure transmitted in wireless from a transmitter disposed in a tire. The monitor receives the pressure information from the receivers through communication line to monitor conditions of the tires. A connector is disposed near the receiver to connect each receiver to the communication line. The connector has a connector element to provide the receiver with an ID.

However, in this communication system of the Publication, a plurality of connectors disposed near the receivers are required to provide the receivers with different IDs, thereby increasing manufacturing costs of the system.

### SUMMARY OF THE INVENTION

An object of the present invention is to provide, with due consideration to the drawbacks of the conventional communication system, a communication system having a master device and a plurality of slave devices wherein an identifier is automatically assigned to each slave device without increasing manufacturing costs of the communication system.

According to an aspect of this invention, the object is achieved by the provision of a communication system comprising a single communication line, a master device and a plurality of slave devices. The master device outputs a plurality of setting request signals, respectively, including a plurality of identifiers different from one another to the communication line one after another. In this case, the master device firstly outputs one of the setting request signals, and outputs one of the other setting request signals each time the master device detects a setting response signal transmitted through the communication line.

Each slave device independently sets a monitoring period of time, receives the setting request signals outputted by the master device from the communication line one after another, and performs an identifier setting judgment every setting request signal. In this judgment, the slave device performs a monitoring operation for the communication line during the monitoring period of time starting upon reception of the setting request signal unless the slave device has outputted a setting response signal, outputs a setting response signal to the communication line in response to the setting request signal when the slave device detects no setting response signal transmitted through the communication line in the monitoring operation, and sets an identifier included in the setting request signal as that assigned to the slave device when the slave device outputs the setting response signal.

Therefore, each time the master device outputs a setting request signal to the communication line, a slave device having the shortest monitoring period of time among those of the slave devices not yet having identifiers assigned to those sets an identifier of the setting request signal as that assigned to the slave device.

Accordingly, different identifiers can be automatically assigned to all slave devices of the communication system, respectively. Further, the communication system can be manufactured at low costs.

Preferably, the master device comprise a master control unit which sets an error judging period of time which is longer than any of the monitoring periods of time set by the slave devices, prepares a plurality of second setting request signals, respectively, including the identifiers unless the master device detects a setting response signal transmitted through the communication line in response to one of the setting request signals during the error judging period of time starting upon the outputting of the setting request signal, adds restart information to one of the second setting request signals, and outputs the second setting request signals to the communication line one after another in a manner that one of the second setting request signals including the restart information is firstly outputted, and one of the other second setting request signals is outputted each time the master device detects a setting response signal transmitted through the communication line.

Each of the slave devices comprises a slave control unit which firstly receives the second setting request signal firstly outputted by the master device from the communication line, then receives the other second setting request signals outputted by the master device from the communication line, detects the restart information included in the second setting request signal firstly received, deletes the identifier in response to the detected restart information if the identifier has been set in the slave device, and performs a second identifier setting judgment every second setting request signal. In this judgment, the slave control unit performs a monitoring operation for the communication line during the monitoring period of time starting upon reception of the second setting request signal unless the slave device has outputted a setting response signal after the reception of the second setting request signal firstly received, outputs a setting response signal to the communication line when the slave control unit detects no setting response signal transmitted through the communication line in the monitoring operation, and sets an identifier included in the second setting request signal as that assigned to the slave device when the slave control unit outputs the setting response signal to the communication line.

Accordingly, even though the simultaneous outputting of setting response signals or a communication failure occurs in the communication system during the assignment of identifiers to the slave devices, the occurrence of a communication error based on erroneous assignment of identifiers to the slave devices can be prevented.

### BRIEF DESCRIPTION OF THE DRAWINGS

FIG. 1 is an explanatory view showing the arrangement of a tire condition supervisory system according to first to fourth embodiments of the present invention;

FIG. 2 is a block diagram of the supervisory system shown in FIG. 1 according to the first embodiment;

FIG. 3 is a flow chart of the receiver ID assignment processing performed in a control circuit of a supervisory ECU shown in FIG. 2 just after the actuation of the supervisory system;

FIG. 4 is a flow chart of the receiver ID assignment and response processing performed in a control circuit of each receiver shown in FIG. 2 just after the actuation of the supervisory system;

FIG. 5 is a block diagram of each receiver according to the second embodiment of the present invention;

FIG. 6 is a block diagram of each receiver according to the third embodiment of the present invention; and

FIG. 7 is a block diagram of each receiver according to the fourth embodiment of the present invention.

### DETAILED DESCRIPTION OF THE PREFERRED EMBODIMENTS

Embodiments of the present invention are now described with reference to the accompanying drawings, in which like reference numerals indicate like parts, members or elements throughout the specification unless otherwise indicated.

A communication system according to this embodiment has a single communication line, a master device and a plurality of slave devices connected to the master device through the single communication line.

The master device outputs a plurality of setting request signals, respectively, including a plurality of identifiers different from one another to the single communication line one after another. The slave devices output a plurality of setting response signals to the single communication line in response to the setting request signals, respectively, and set the identifiers as those assigned thereto, respectively.

More particularly, the master device firstly outputs a setting request signal to the communication line. Then, each time the master device detects a setting response signal outputted by one of the slave devices and transmitted through the communication line, the master device outputs one of the other setting request signals to the communication line. That is, the master devices outputs the other setting request signals in response to detected setting response signals.

Each of the slave devices independently sets a monitoring period of time, receives the setting request signals of the master device from the communication line one after another, and performs an identifier setting judgment every setting request signal. In this judgment, unless the slave device has outputted a setting response signal to the communication line (or unless no identifier has assigned to the slave device), the slave device performs a monitoring operation for the communication line during the monitoring period of time starting upon reception of the setting request signal. When the slave device detects no setting response signal outputted by the other slave devices and transmitted through the communication line in the monitoring operation, the slave device outputs a setting response signal to the communication line, and sets an identifier included in the setting request signal as that assigned to the slave device.

Because monitoring periods of time are independently set in the slave devices, the monitoring periods of time are different from one another. Therefore, each time the master device outputs a setting request signal to the communication line, a slave device having the shortest monitoring period of time among those of the slave devices not yet having identifiers assigned to those sets an identifier of the setting request signal as that assigned to the slave device. Then, the master device outputs a next setting request signal to the communication line in response to the setting response signal outputted by the slave device having the shortest monitoring period of time.

Accordingly, when the master device sequentially outputs a plurality of setting request signals to the communication line, different identifiers can be automatically assigned to all slave devices of the communication system, respectively. Therefore, it is not required to manually assign an identifier to each slave device by manipulating a DIP switch, or to dispose a connector near each slave device for the purpose of assigning an identifier of the connector to the slave device. As a result, the communication system according to this embodiment can be manufactured at a low cost.

In this embodiment, although the monitoring periods of time are independently set in all slave devices of the communication system so as to differ from one another, there is a very low probability that monitoring periods of time set in two slave devices are the same as each other. When slave devices set the same monitoring period of time as each other, the slave devices simultaneously output setting response signals to the communication line, and identifiers assigned to the slave devices undesirably become the same as each other.

In this case, the master device and the other slave devices cannot detect each of the setting response signals simultaneously outputted to the communication line but recognize the signals as noises. Therefore, a third slave device having the shortest monitoring period of time among those of the other slave devices erroneously outputs a setting response signal to the communication line, and the master device outputs a next setting request signal to the communication line in response to the setting response signal of the third slave device. Therefore, the master device continues outputting the other setting request signals without noticing that the two slave devices erroneously set the same identifier.

In this situation, when the number of setting request signals outputted from the master device is set to equal to the number of slave devices of the communication system for the purpose of assigning different identifiers to the slave devices, the number of setting response signals detected in the master device becomes lower than the number of setting request signals outputted from the master device. Therefore, when the master device sequentially outputs a plurality of setting request signals to the communication line, it is sure that no slave device outputs a setting response signal in response to one of the setting request signals. In this case, even though the master device waits for a setting response signal during a certain long period of time which starts from an outputting time of the setting request signal (that is, a reception time of the setting request signal in the slave devices) and is longer than any of the monitoring periods of time, the master device cannot detect a setting response signal after the outputting of a setting request signal.

As a result, identifiers cannot correctly be assigned to the slave devices. This problem is not limited to a case where setting response signals are simultaneously outputted. For example, when a communication failure occurs in the communication system due to an electro-magnetic disturbance from outside or the like, no detection of a setting response signal occurs in the master device.

To solve this problem, it is required to cancel the assignment of identifiers already performed and again assign identifiers to the slave devices.

To satisfy this requirement, the master device sets an error judging period of time which is longer than any of the monitoring periods of time set by the slave devices. Unless the master device detects a setting response signal transmitted through the communication line in response to one of the setting request signals during the error judging period of time starting upon the outputting of the setting request signal, the master device prepares a plurality of second setting request signals, respectively, including the identifiers, and adds restart information to at least one of the second setting request signals. Then, the master device outputs the second setting request signals to the communication line one after another. More particularly, the master device firstly outputs the second setting request signal including the restart information, and the master device outputs one of the other second setting request signals to the communication line each time the master device detects a setting response signal outputted by one of the slave devices and transmitted through the communication line.

Each slave device firstly receives the second setting request signal firstly outputted by the master device from the communication line, and detects the restart information included in the second setting request signal firstly received. When the slave device has already had an identifier assigned thereto, the slave device deletes the identifier in response to the restart information. Further, each slave device performs a second identifier setting judgment every second setting request signal received from the communication line. In this judgment, the slave device monitors the communication line during the monitoring period of time starting upon reception of the second setting request signal. When the slave device detects no setting response signal outputted by one of the other slave devices and transmitted through the communication line, the slave device outputs a setting response signal to the communication line in response to the second setting request signal just after the monitoring period of time of the slave device, and then sets an identifier of the second setting request signal as that assigned to the slave device.

Therefore, even though the simultaneous outputting of setting response signals or a communication failure occurs in the communication system during the assignment of identifiers to the slave devices, the master device can automatically detect an erroneous assignment of identifiers, and the communication system can assign identifiers to the slave devices again. Accordingly, the occurrence of a communication error caused by erroneous assignment of identifiers to the slave devices can be prevented. Further, because a user is not required to recognize such a communication error or to manually operate again the communication system for the assignment of identifiers, the user can easily assign identifiers to the slave devices.

An example of the communication system applied to a tire condition supervisory system is described with reference to the accompanying drawings.

### Embodiment 1

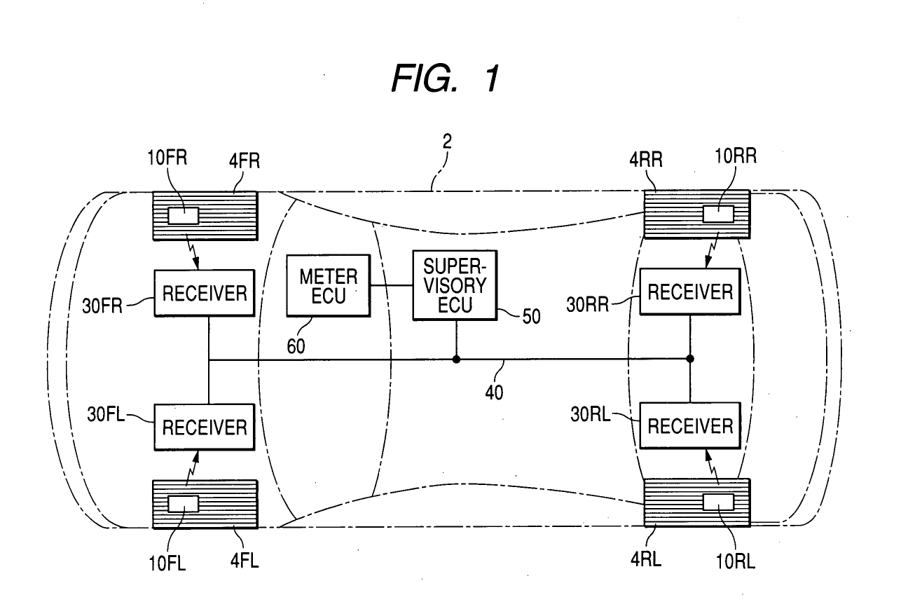

FIG. 1 is an explanatory view showing the arrangement of a tire condition supervisory system according to first to fourth embodiments of the present invention.

As shown in FIG. 1, a vehicle 2 has four tubeless tires 4 (4FL, 4FR, 4RL and 4RR) of four wheels (front-left wheel FL, front-right wheel FR, rear-left wheel RL and rear-right wheel RR). A tire condition supervisory system mounted on the vehicle 2 has four detectors 10 (10FL, 10FR, 10RL and 10RR), respectively, disposed into the tires 4, four receivers 30 (30FL, 30FR, 30RL and 30RR), respectively, disposed near the tires 4, a supervisory electronic control unit (ECU) 50, a communication line (or single wire) 40 connecting the receivers 30 with the supervisory ECU 50, and a meter ECU 60.

Each detector 10 detects tire inflation pressure and temperature of air compressed in the corresponding tire 4 every predetermined period of time, and transmits detected values of the inflation pressure and temperature to the corresponding receiver 30. The predetermined periods of time set in the detectors 10 differ from one another.

Each receiver 30 performs an LIN communication with the supervisory ECU 50 through the communication line 40. Each receiver 30 transmits tire information including the detected values of the detector 10 to the supervisory ECU 50 through the communication line 40 in response to a communication request signal of the supervisory ECU 50. Therefore, the supervisory ECU 50 functions as a master device, and a combination of each detector 10 and the corresponding receiver 30 functions as a slave device.

The meter ECU 60 controls meter elements such as a speed meter disposed in front of a driver seat, display panels for displaying various types of information, and an alarm lamp. The supervisory ECU 50 informs a driver of the tire information (for example, tire conditions such as sudden punctuation of tire, natural air leaking from tire and the like) through the meter ECU 60.

The receivers 30, the supervisory ECU 50 and the meter ECU 60 are disposed into a body of the vehicle 2 and are operated by receiving electric power from an in-vehicle storage battery (not shown). In contrast, the detectors 10 are disposed into the tires 4, so that the detectors 10 cannot receive electric power from the in-vehicle storage battery. Therefore, each detector 10 receives electric power from a small battery attached to the corresponding tire 4.

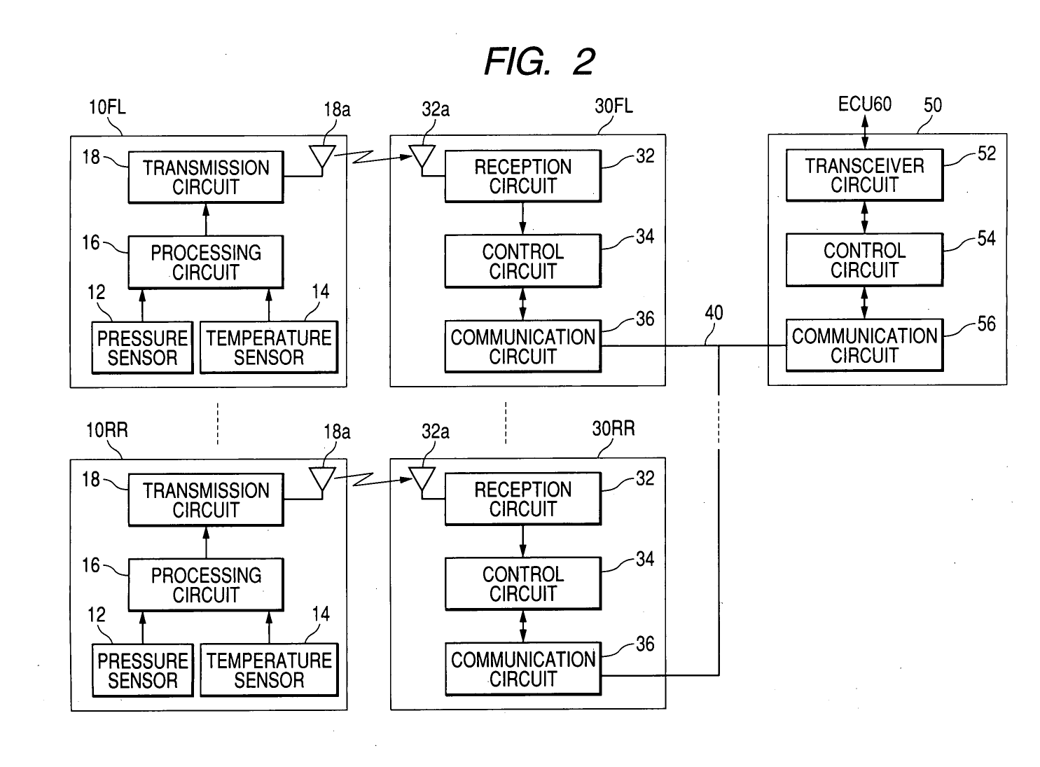

FIG. 2 is a block diagram of the supervisory system. As shown in FIG. 2, each detector 10 has a pressure sensor 12 which detects inflation pressure of the tire 4, a temperature sensor 14 which detects temperature of the tire 4, a processing circuit 16 which receives detection signals of the inflation pressure and temperature from the sensors 12 and 14, obtains detection data indicating values of the detected inflation pressure and temperature, generates tire information by adding identification information (hereinafter, named tire ID) of the corresponding tire 4 to the detection data, and a transmission circuit 18 with an antenna 18a which transmits the tire information to the receiver 30. The processing circuit 16 is intermittently operated at predetermined transmission time intervals. The transmission circuit 18 modulates carrier waves of a predetermined frequency according to the tire information to produce a transmission signal, and the antenna 18a periodically transmits the transmission signal to the receiver 30 in wireless.

Each receiver 30 has a reception circuit 32 with an antenna 32a which receives the transmission signal from the detector 10 through the antenna 32a and demodulates the transmission signal to the tire information, a communication circuit 36 which communicates with the supervisory ECU 50 through the communication line 40, and a control circuit 34 configured by a microcomputer having a central processing unit (CPU). The control circuit 34 stores an identifier (hereinafter, named receiver ID) of the receiver 30 set to identify the receiver 30 and to distinguish the receiver 30 from the other receivers 30. The receiver IDs of the receivers 30 differ from one another. In response to a communication request signal with the receiver ID transmitted from the supervisory ECU 50, the control circuit 34 adds its receiver ID to the tire information demodulated in the reception circuit 32 and instructs the communication circuit 36 to transmit the tire information to the supervisory ECU 50 through the communication line 40.

The supervisory ECU 50 has a transceiver circuit 52 which receives and transmits data from/to the meter ECU 60, a communication circuit 56 which communicates with the receivers 30 through the communication line 40, and a control circuit 54 configured by a microcomputer having a CPU.

In operation, the control circuit 54 of the supervisory ECU 50 generates a communication request signal including a receiver ID and instructs the communication circuit 56 to output the communication request signal to the communication line 40. When the communication circuit 36 of each receiver 30 receives the communication request signal from the communication line 40, the control circuit 34 read outs the receiver ID from the signal and compares the receiver ID read out with the receiver ID stored thereof. When the receiver IDs are the same as each other in one of the receivers 30, the control circuit 34 of the receiver 30 instructs the communication circuit 36 to output a communication response signal including tire information (tire inflation pressure and tire temperature), a tire ID and the receiver ID of the receiver 30 to the communication line 40.

When the communication circuit 56 of the supervisory ECU 50 receives the communication response signal transmitted through the communication line 40, the control circuit 54 demultiplexes the communication response signal into the tire information, the tire ID and the receiver ID. When the received receiver ID is the same as the receiver ID of the communication request signal currently outputted, the control circuit 54 recognizes that the received tire information is correctly transmitted from the desired receiver 30 in response to the communication request signal. Then, the control circuit 54 checks the tire information. When the tire information indicates unusual conditions of tire, the control circuit 54 specifies one of the tires 4 based on the tire ID and informs the meter ECU 60 that the specified tire 4 is under unusual conditions. The meter ECU 60 turns on a tire inflation pressure alarming lamp disposed in front of the driver seat.

In this example, the assignment of the receiver ID to the receiver 30 is not performed only once, but the receiver ID is assigned to the receiver 30 each time an ignition switch of the vehicle 2 is turned on. More particularly, electric power is supplied from an in-vehicle storage battery to the supervisory ECU 50 and the receivers 30 in response to the turning-on of the ignition switch, and the supervisory system is actuated to start its assignment operation. Then, each receiver 30 automatically receives a corresponding receiver ID as an assigned receiver ID by performing the communication between the supervisory ECU 50 and the receiver 30.

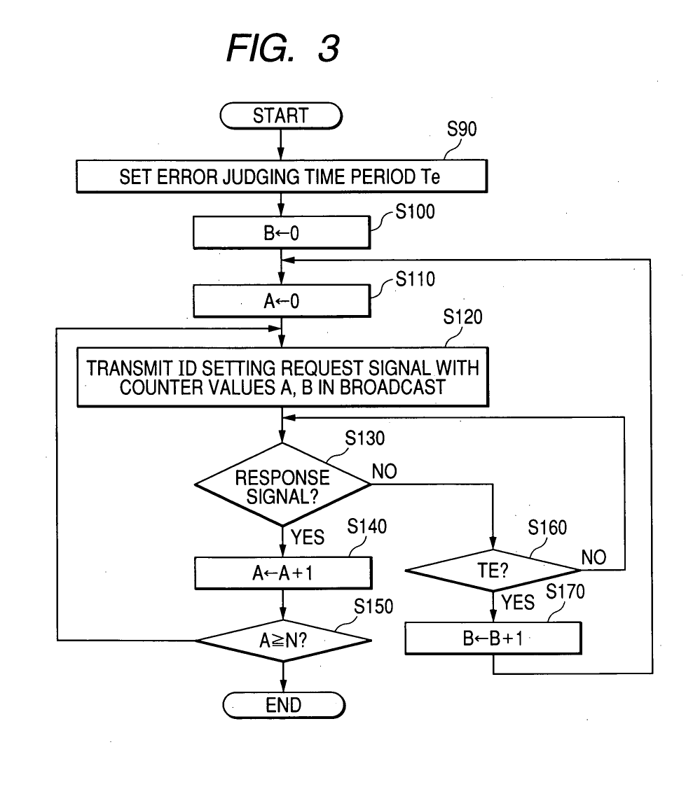

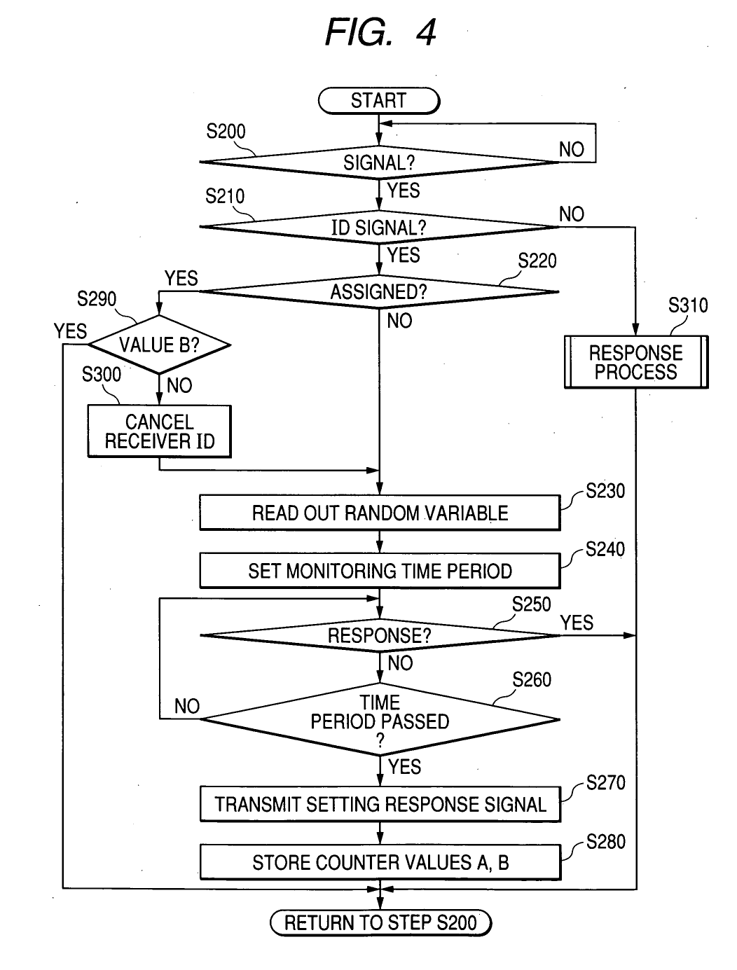

The automatic assignment of the receiver IDs in the supervisory system is described with reference to FIGS. 3 and 4. FIG. 3 is a flow chart of the receiver ID assignment processing performed in the control circuit 54 of the supervisory ECU 50 just after the actuation of the supervisory system.

As shown in FIG. 3, at step S90 of the receiver ID setting processing, an error judging time period Te is set. The error judging time period Te has been known in the receivers 30.

At step S110, a counter value B is set at an initial value of “0”. The counter value B indicates the number of resetting operations of a group of receiver IDs (or restart information).

At step S110, a counter value A is set at an initial value of “0”. The counter value A indicates a receiver ID to be assigned to one of the receivers 30. It is planned to assign the receiver IDs set at “0”, “1”, “2” and “3” to the receivers 30, respectively.

At step S120, an ID setting request signal with the counter values A and B is simultaneously transmitted in broadcast to all receivers 30 though the communication line 40. Then, the control circuit 54 monitors the communication line 40 to detect a setting response signal transmitted through the communication line 40 in response to the ID setting request signal.

FIG. 4 is a flow chart of the receiver ID assignment and response processing performed in the control circuit 34 of each receiver 30 just after the actuation of the supervisory system.

As shown in FIG. 4, at step S200, the control circuit 34 of each receiver 30 waits for a request signal transmitted from the supervisory ECU 50.

When a request signal is received from the communication line 40, it is judged at step S210 whether or not the received request signal is an ID setting request signal transmitted from the supervisory ECU 50.

In case of negative judgment, a response process (for example, transmission of tire information to the supervisory ECU 50) corresponding to the received request signal is performed at a step S310, and the procedure returns to the step S200.

In contrast, in case of affirmative judgment, it is judged at step S220 whether or not a receiver ID has been already assigned to this receiver 30.

In case of negative judgment, a random variable R of a free run counter is read out at step S230. The random variable R differs from those of the other receivers 30 at high probability.

At step S240, a monitoring time period Td (Td=R×S) shorter than the error judging time period Te set in the supervisory ECU 50 is set by multiplying a preset time period S by the random variable R.

At step S250, the control circuit 34 starts monitoring the communication line 40 to detect a setting response signal outputted by one of the other receivers 30, and it is judged whether or not a setting response signal outputted by one of the other receivers 30 is transmitted through the communication line 40. In case of affirmative judgment, the control circuit 34 recognizes that the counter value A of the ID setting request signal is assigned to one of the other receivers 30 as a receiver ID, and the procedure returns to the step S200.

In contrast, in case of negative judgment at step S250, it is judged at step S260 whether or not the monitoring time period Td has passed after the starting of the monitoring operation. In case of negative judgment, the procedure returns to the step S250.

That is, at steps S250 and S260, it is judged whether or not one of the other receivers 30 outputs a setting response signal during the monitoring time period Td starting from the reception of the ID setting request signal.

When the monitoring time period Td has passed, the control circuit 34 recognizes that none of the other receivers 30 outputs a setting response signal during the monitoring time period Td, and the monitoring time period Td of this receiver 30 is the shortest among those of the receivers 30 which have not yet outputted a setting response signal. Therefore, at step S270, the control circuit 34 instructs the communication circuit 36 to output a setting response signal to the communication line 40.

At step S280, the control circuit 34 reads out the counter values A and B from the ID setting request signal currently received, stores and sets the counter value A as a receiver ID assigned to this receiver 30, and stores the counter value B. The counter values A and B are stored in a memory such as a random access memory (RAM) or the like. Then, the procedure returns to the step S200 to wait for another request signal.

Returning to FIG. 3, at step S130, the control circuit 54 of the supervisory ECU 50 judges whether or not a setting response signal outputted by one of the receivers 30 in response to the ID setting request signal currently outputted is transmitted through the communication line 40.

Before one of the monitoring time periods Td set in the receivers 30 has passed, no receiver 30 transmits a setting response signal. Therefore, at step S130, a negative result is obtained at the first judgment.

At step S160, it is judged whether or not the error judging time period Te starting from the outputting of the ID setting request signal recently outputted has passed. Because the error judging time period Te is set to be longer than any of the time periods Td of the receivers 30, a negative result is obtained at the first judgment.

When one of the receivers 30 outputs a setting response signal after passage of its monitoring time period Td, affirmative judgment is held at step S130.

Then, at step S140, the counter value A indicating a receiver ID is incremented by one. The counter value A incremented equals to the number of receivers 30 to which receiver IDs have been assigned.

At step S150, it is judged whether or not the counter value A is higher than the number N of all receivers 30 of the supervisory system.

In case of negative judgment at step S150, the control circuit 54 recognizes that receiver IDs have not yet been assigned to all receivers 30, and the procedure returns to step S120. Therefore, until receiver IDs have been assigned to all receivers 30, an ID setting request signal with the incremented counter value A and the counter value B is broadcasted to all receivers 30 though the communication line 40 every reception of one setting response signal.

Returning to FIG. 4, in each of receivers 30 to which receivers ID have been already assigned in response to ID setting request signals previously received, affirmative judgment is obtained in response to the ID setting request signal currently received at step S220. Then, the counter value B is read out from the memory, and it is judged at step S290 whether or not the counter value B read out is the same as that of the ID setting request signal currently received. Because the counter value B has not yet be changed, affirmative judgment is obtained at step S290. Therefore, the control circuit 54 recognizes that the receiver ID already assigned to the receiver 30 is correct. Then, the procedure returns to the step S200.

In contrast, in one of receivers 30 to which a receiver ID has not yet been assigned, a setting response signal is outputted from the receiver 30 at step S270, and a receiver ID of the ID setting request signal currently received is assigned to the receiver 30 at step S280.

Therefore, each time an ID setting request signal is outputted from the supervisory ECU 50, a receiver ID of the ID setting request signal is automatically assigned to one of receivers 30. When receiver ID shave been assigned to all receivers 30, the assignment of the receivers ID to all receivers 30 is completed.

However, when the simultaneous outputting of setting response signals or a communication failure occurs in the supervisory system, no setting response signal is transmitted through the communication line 40 in response to an ID setting request signal recently outputted. In this case, affirmative judgment is obtained at step S160. Then, the counter value B is incremented by one at step S170, and the counter value A is again set at an initial value “0” at step S110. Thereafter, a plurality of ID setting request signals are again sequentially outputted to the receivers 30 at steps S120 to S160.

Returning to FIG. 4, in each of receivers 30 to which receivers ID have been already assigned in response to ID setting request signals previously received, negative judgment is obtained at step S290, and the receiver ID assigned to the receiver 30 is cancelled at step S300.

Therefore, each time the supervisory ECU 50 outputs an ID setting request signal to the receivers 30 through the communication line 40, a receiver ID of the ID setting request signal is automatically assigned to one of receivers 30 to which a receiver ID has not yet been assigned. When receiver IDs have been assigned to all receivers 30, the assignment of the receivers ID to all receivers 30 is completed.

As described above, in this tire condition supervisory system, when the system is actuated, the supervisory ECU 50 (or master device) sequentially transmits ID setting request signals, respectively, including receiver IDs to the receivers (or slave devices) 30 through the communication line 40. In this case, each ID setting request signal subsequent to a preceding ID setting request signal is outputted when a setting response signal transmitted from one of the receivers 30 is detected.

Each of the receivers 30 receives the ID setting request signals from the supervisory ECU 50 one after another, and sets a monitoring time period Td based on a random variable R. When the receiver 30 has not yet set a receiver ID at a reception time of one ID setting request signal currently received, the receiver 30 starts monitoring the communication line 40 during the monitoring time period Td to detect a setting response signal outputted by one of the other receivers 30 on the communication line. When the monitoring time period Td has passed without detecting a setting response signal, the receiver 30 transmits a setting response signal to the supervisory ECU 50 through the communication line 40 and sets the receiver ID (or identifier) of the current ID setting request signal in the receiver 30. That is, the receiver ID is assigned to the receiver 30.

Accordingly, in this example, when the supervisory ECU 50 sequentially outputs ID setting request signals including different receiver IDs, the receiver IDs can automatically be set in all receivers 30 of the supervisory system, respectively. Therefore, a user cannot be required to manually assign the receiver IDs to the receivers.

Further, because the automatic assignment of the receiver IDs is performed during the communication between the supervisory ECU 50 and each receiver 30, none of DIP switch or connectors are required. Therefore, the supervisory system for the automatic assignment of the receiver IDs to the receivers can be manufactured at low cost.

Moreover, when simultaneous outputting of setting response signals to the communication line 40 or a communication failure occurs in the supervisory system during the automatic assignment of the receiver IDs, receiver IDs already assigned to receivers 30 are automatically cancelled, and the automatic assignment of the receiver IDs to all receivers 30 are again performed. Accordingly, even though simultaneously outputting of setting response signals or a communication failure occurs, different receiver IDs can be reliably assigned to the receivers 30, respectively.

In the first embodiment, each monitoring time period Td is determined from the random variable R obtained in the free run counter. However, the setting of the monitoring time periods Td is not limited to this embodiment. Various configurations of the receiver 30 setting a monitoring time periods Td are described in the following embodiments.

### Embodiment 2

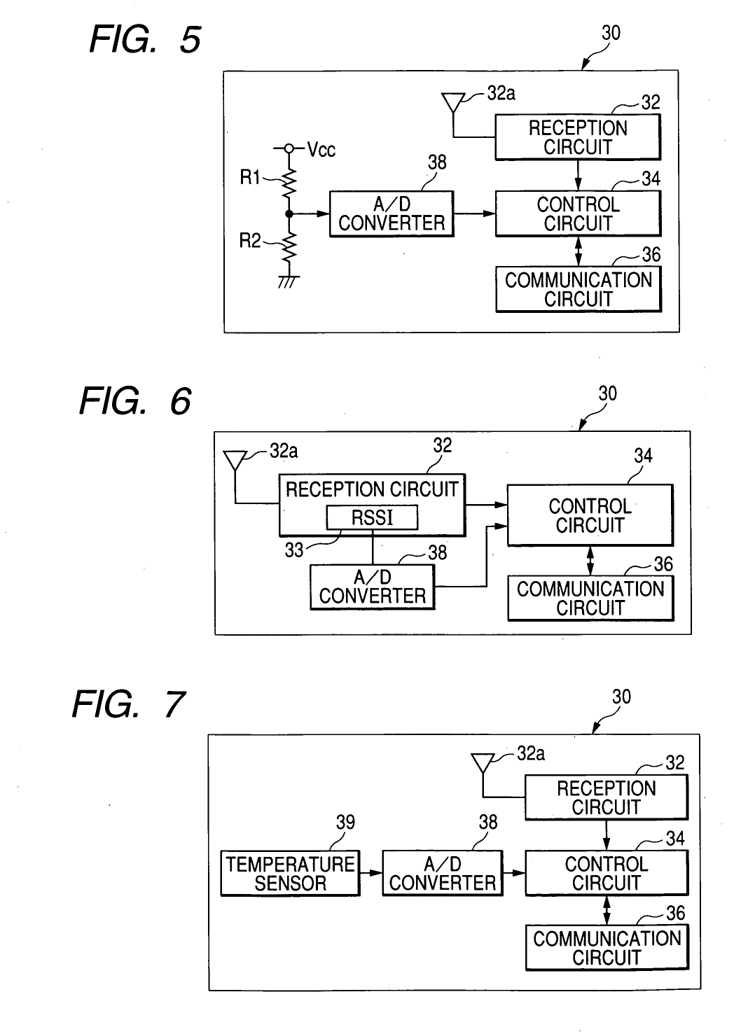

FIG. 5 is a block diagram of each receiver 30 according to a second embodiment of the present invention.

Each receiver 30 further has two voltage dividing resistors R1 and R2 which divides a source voltage Vcc applied to a terminal of the resistor R1, and an analog-to-digital (A/D) converter 38. Another terminal of the resistor R1 is connected with a terminal of the resistor R2 at a connection point, and another terminal of the resistor R2 is earthed. The A/D converter 38 converts a divided voltage obtained at the connection point into a random variable R, and the control circuit 34 determines a monitoring time period Td from the random variable R.

The resistors R1 and R2 and a power source circuit of the source voltage Vcc are manufactured with predetermined precision, so that resistance values of the resistors R1 and R2 and the source voltage Vcc in each receiver 30 differ from those of the other receivers 30. Therefore, the monitoring time periods Td different from one another can reliably be obtained in the receivers 30.

When the precision in the manufacturing of the resistors R1 and R2 and the power source circuit is very high, the resistance values of the resistors R1 and R2 and the source voltage Vcc in each receiver 30 undesirably become similar to those of the other receivers 30. Therefore, it is preferred that the resistors R1 and R2 and the power source circuit are manufactured with comparatively low precision to roughly set the resistance values and the source voltage Vcc in each receiver 30 on condition that the manufacturing precision does not influence on the communication between the supervisory ECU 50 and the receiver 30.

### Embodiment 3

FIG. 6 is a block diagram of each receiver 30 according to a third embodiment of the present invention.

Each receiver 30 further has a received signal strength indicator (RSSI) 33 disposed in the reception circuit 32, and the A/D converter 38. The RSSI 33 generates a strength value of a reception signal received at the antenna 32a and indicates the strength of the reception signal. The RSSI 33 outputs a voltage signal indicating the strength value of the reception signal, and the A/D converter 38 converts the voltage signal into a random variable R. The control circuit 34 determines a monitoring time period Td from the random variable R.

The reception signal received at the antenna 32a is transmitted from the antenna 18a of the corresponding detector 10. Because the antennas 32a of the receivers 30 are disposed at positions different from one another, electro-magnetic conditions for each antenna 32a differ from those for the other antennas 32a. Therefore, the strength of the reception signal received at each antenna 32a differs from those of the other antennas 32a. As a result, the monitoring time periods Td different from one another can reliably be obtained in the receivers 30.

### Embodiment 4

FIG. 7 is a block diagram of each receiver 30 according to a fourth embodiment of the present invention.

Each receiver 30 further has a temperature sensor 39, and the A/D converter 38. The temperature sensor 39 detects a temperature of surrounding atmosphere, and the A/D converter 38 converts the detected temperature into a random variable R. The control circuit 34 determines a monitoring time period Td from the random variable R.

Because the receivers 30 are disposed at positions different from one another, temperature values detected by the temperature sensors 39 differ from one another. Therefore, the monitoring time periods Td different from one another can reliably be obtained in the receivers 30.

In the first to fourth embodiments, the number of setting request signals set in the supervisory ECU 50 (or master device) is set at step S150 to be equal to the number of slave devices. However, the number of setting request signals may be lower than the number of slave devices. For example, the number of setting request signals is set to be lower than the number of slave devices by one, and a particular identifier different from identifiers included in the setting request signals is initially assigned to all receivers (or slave devices) In this case, when the automatic assignment of the identifiers is performed by sequentially transmitting the setting request signals to the receivers, the identifiers are, respectively, assigned to all receivers but a particular receiver having the longest monitoring period of time. The particular receiver maintains the particular identifier assigned thereto.

Further, the communication system according to the present invention is applied to the tire condition supervisory system. However, the communication system can be applied to any system in which a first device is connected with a plurality of second devices through a common communication line to transmit information from each second device to the first device through the communication line in response to a request of the first device.

What is claimed is:

1. A communication system comprising:
a single communication line;
a master device which outputs a plurality of setting request signals, respectively, including a plurality of identifiers different from one another to the communication line one after another in a manner that one of the setting request signals is firstly outputted, and one of the other setting request signals is outputted each time the master device detects a setting response signal transmitted through the communication line; and
a plurality of slave devices each of which independently sets a monitoring period of time, receives the setting request signals outputted by the master device from the communication line one after another, and performs an identifier setting judgment every setting request signal in a manner that the slave device performs a monitoring operation for the communication line during the monitoring period of time starting upon reception of the setting request signal unless the slave device has outputted a setting response signal, outputs a setting response signal to the communication line when the slave device detects no setting response signal transmitted through the communication line in the monitoring operation, and sets an identifier included in the setting request signal as that assigned to the slave device when the slave device outputs the setting response signal.

2. The communication system according to claim 1, wherein the master device comprises a master control unit which sets an error judging period of time which is longer than any of the monitoring periods of time set by the slave devices, prepares a plurality of second setting request signals, respectively, including the identifiers unless the master device detects a setting response signal transmitted through the communication line in response to one of the setting request signals during the error judging period of time starting upon the outputting of the setting request signal, adds restart information to one of the second setting request signals, and outputs the second setting request signals to the communication line one after another in a manner that one of the second setting request signals including the restart information is firstly outputted, and one of the other second setting request signals is outputted each time the master device detects a setting response signal transmitted through the communication line, and
each of the slave devices comprises a slave control unit which firstly receives the second setting request signal firstly outputted by the master device from the communication line, then receives the other second setting request signals outputted by the master device from the communication line, detects the restart information included in the second setting request signal firstly received, deletes the identifier in response to the detected restart information if the identifier has been set in the slave device, and performs a second identifier setting judgment every second setting request signal in a manner that the slave control unit performs a monitoring operation for the communication line during the monitoring period of time starting upon reception of the second setting request signal unless the slave device has outputted a setting response signal after the reception of the second setting request signal firstly received, outputs a setting response signal to the communication line when the slave control unit detects no setting response signal transmitted through the communication line in the monitoring operation, and sets an identifier included in the second setting request signal as that assigned to the slave device when the slave control unit outputs the setting response signal to the communication line.

3. The communication system according to claim 2, wherein the master control unit of the master device sets the number of setting request signals sequentially outputted from the master device to be equal to the number of slave devices.

4. The communication system according to claim 2, wherein the master control unit of the master device sets the number of second setting request signals sequentially outputted from the master device to be equal to the number of slave devices.

5. The communication system according to claim 1, wherein each of the slave devices generates a variable value in random and sets the variable value as the monitoring period of time.

6. The communication system according to claim 1, wherein
the master device comprises a master communication unit which outputs a communication request signal including one of the identifiers to the communication line, and receives a communication response signal through the communication line, and
each of the slave devices comprises a slave communication unit which receives the communication request signal outputted from the master unit through the communication line, detects the identifier included in the communication request signal, and outputs the communication response signal to the communication line in response to the communication request signal when the detected identifier agrees to the identifier of the slave device.

7. The communication system according to claim 1, wherein each time the communication system is actuated, the master device sequentially outputs the setting request signals to the communication line to assign the identifiers to the slave devices.

8. The communication system according to claim 1, wherein each of the slave devices has a voltage dividing resistor, having a peculiar resistance different from those of the other slave devices, which receives a source voltage and generates a divided voltage depending on the independent resistance from the source voltage, and a control unit which sets a peculiar value corresponding to the divided voltage as the monitoring period of time.

9. The communication system according to claim 1, wherein each of the slave devices has a receiver which receives a detection signal indicating a detection result of a detector and detects a peculiar strength of the detection signal, and a control unit which sets a peculiar value corresponding to the peculiar strength of the detection signal as the monitoring period of time.

10. The communication system according to claim 1, wherein each of the slave devices has a temperature detector which detects a temperature of an object, and a control unit which sets a peculiar value corresponding to the detected temperature as the monitoring period of time.
